(19) United States
(12) Patent Application Publication
(10) Pub. No.: US 2012/0090218 A1
(43) Pub. Date: Apr. 19, 2012

(54) FISHING WEIGHT

(76) Inventor: MATTHEW SAWRIE, London (CA)

(21) Appl. No.: 13/289,205

(22) Filed: Nov. 4, 2011

Related U.S. Application Data
(63) Continuation of application No. 12/379,721, filed on Feb. 27, 2009, now abandoned.

(51) Int. Cl. A01K 95/00

(52) U.S. Cl. 43/43.1

(57) ABSTRACT

The fishing weight comprises a hydrodynamically torpedo shaped body, having fins to impart hydrodynamic stability. The torpedo body has a constant circular cross section and a rounded nose and an aft end which is downwardly and rearwardly tapered to intersect and blend with the fins and sinks quickly to a desired fishing depth. A suitable fishing gear attachment means is placed above the centre of gravity of the fishing weight which permits the weight to be towed by the boat and also permits fishing gear to be attached thereto by suitable means to extend rearwardly of the weight, which when struck by a fish creates an automatic hook setting action.

### CROSS-REFERENCE TO RELATED APPLICATIONS

This application is a non-provisional of U.S. Ser. No. 61/064,344, filed Feb. 29, 2008, which is incorporated by reference as if fully recited herein.

### TECHNICAL FIELD

The invention relates to an improved fishing weight for reaching greater fishing depths without the use of down rigger or planing diver apparatus. The fishing weight according to the present invention reduces the amount of set up time required to achieve the desired depths and further permits the use of multiple lines to reach multiple depths. The improved fishing weight comprises a torpedo shaped body to reduce drag and stability fins which allows the weight to reach and maintain a desired depth when trolling. A further feature is an automatic hook setting action when a fish strikes the lure connected to the weight.

### BACKGROUND OF THE ART

Conventional fishing weights are typically spherically or cylindrically shaped. One disadvantage with conventional weights is that they create significant water resistance when used in trolling resulting in upward movement of the line. Accordingly, more fishing line is required to be used with conventional weights to achieve a given depth.

The further problem with conventional weights is the requirement to use stronger and therefore thicker fishing lines to support the conventional weight when trolling at depth. Thicker fishing lines are generally more expensive and less responsive to fish strikes. Thicker fishing lines also have a greater tendency to kink and accordingly become prone to breaking with prolonged use.

Further problems with conventional weights relate to the attenuation of the sensation of a fish strike over the longer distances of fishing line required and also the increased likelihood of tangling or fouling when multiple lines are used.

Down riggers and planing diving devices such as Dipsy Divers are known systems used for trolling at depths and may be used with multiple lines. Down riggers require the use of expensive equipment which must be mounted and installed on boats and require significant setup and preparation time. Similarly planing diving devices are also expensive when compared to conventional weights and require increased set up times. Their use is limited to trolling as they are driven to depth by being pulled through the water by the boat.

### SUMMARY OF THE INVENTION

The present invention is a cost effective solution to reaching a desired fishing depth quickly and efficiently. The improved fishing weight according to the present invention approximates the functionality of a down rigger and planning diving device without the disadvantages of having to purchase expensive equipment which requires mounting installation on a boat. The significant reduction in both the set up time and the time required to reach a desired depth may be significant when the fish are active.

According to the present invention a fishing weight comprising a torpedo shaped body of constant circular cross-section having a rounded nose and stability fins at the rear integral with the body and means, such as an eyelet, to attach fishing line to the body substantially above the center of gravity of the weight. The attachment means may also be integral to the body.

The ratio of the length of the body to the cross-section is preferably between 10 and 21 to 1.

The rear of the torpedo shaped body is a cone structure curving downwardly and rearwardly at a preferred angle of between five and seven degrees from the longitudinal axis of the body.

In a preferred embodiment, at least two stability fins are located opposite one another, for example in either the horizontal or vertical plane and may be deformable such that they may be angled to preferentially direct the weight left, right, up or down.

The body material may be any type of alloy or metal, such as stainless steel, however, softer metals, such as lead, will require the inclusion of a stiffening member for heavier weights.

Finally, the body of the fishing weight may be coated with a hydrophobic coating to further reduce water resistance.

### BRIEF DESCRIPTION OF THE DRAWINGS

In order that the invention may be more clearly understood, embodiments thereof will now be described in detail by way of example, with reference to the accompanying drawings, in which identical parts are identified by identical part numbers and in which:

FIG. 1 is a perspective view of the fishing weight according to this invention.

FIG. 2 is a plan view of the fishing weight according to this invention and includes an enlarged Section A view as shown.

FIG. 3 is the front view of the fishing weight according to this invention.

FIG. 4 is the end view of the fishing weight according to this invention.

### DESCRIPTION OF THE PREFERRED EMBODIMENTS

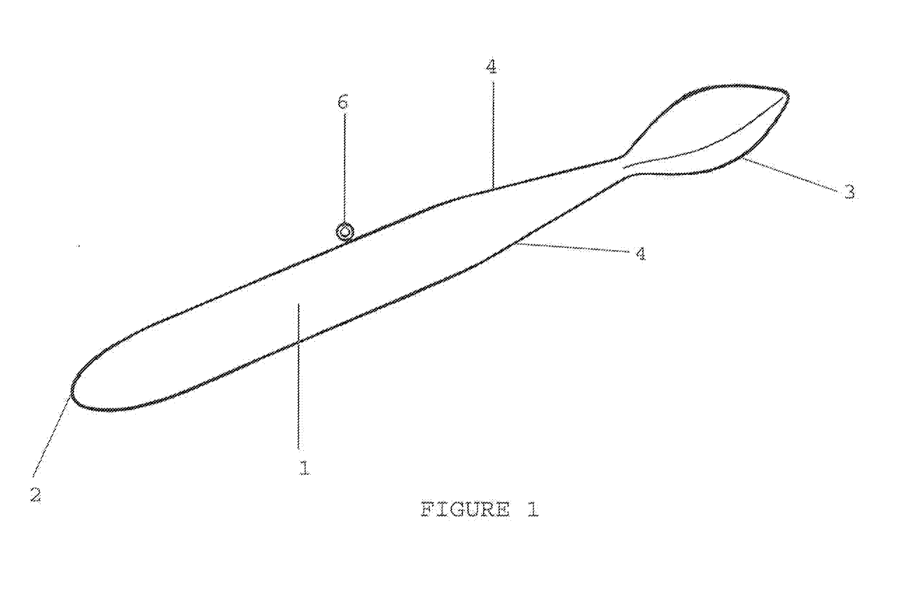

Referring to FIG. 1, a fishing weight according to this invention is illustrated.

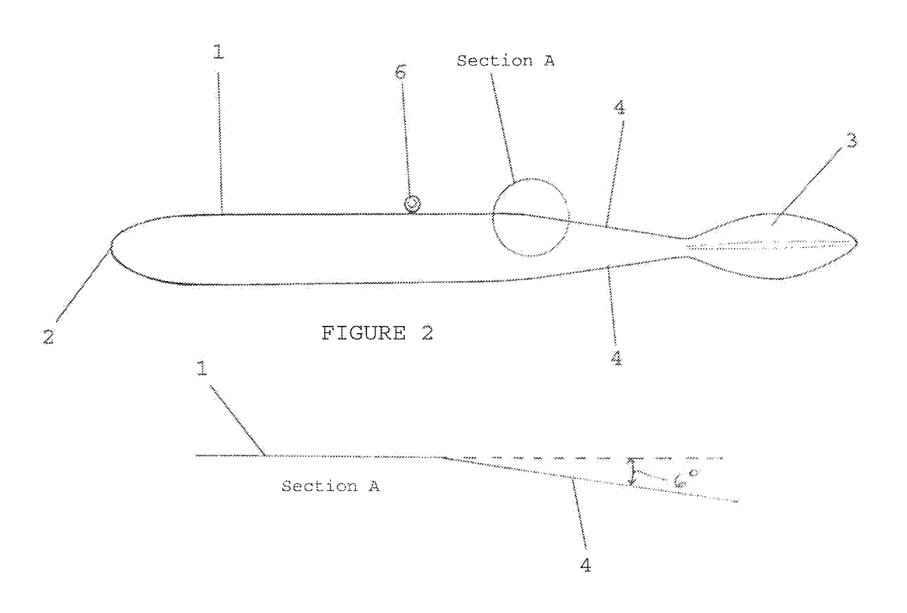

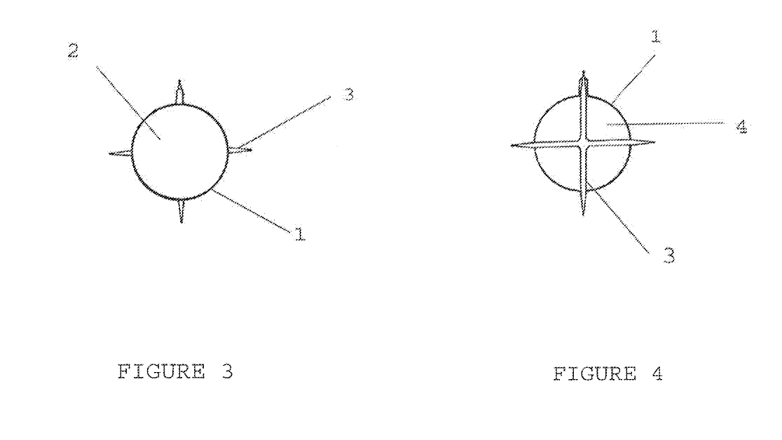

Referring to FIGS. 2, 3 and 4 the inventive fishing weight comprises a torpedo shaped body 1, having fins 3 to impart hydrodynamic stability. There is a torpedo body section of constant circular cross section having diameter d with a forward rounded nose 2. Aft of the torpedo body and integral therewith are a set of four fins 3 at right angles to each other. An important hydrodynamic feature relates to the downwardly and rearwardly tapered trailing edge 4 of the torpedo body at an angle of 06°±1° to intersect and blend with the fin sections 3.

Referring to FIGS. 1, 2, 3 and 4, suitable fishing gear attachment means 6, such as an eyelet, is placed above the centre of gravity of the fishing weight which permits the weight to be towed by the boat and also permits fishing gear to be attached thereto by suitable means to extend rearwardly of the weight. The location of this attachment may be longitudinally adjusted forwardly to give the weight a slightly nose up attitude when towed which is preferable but not essential.

In use, the fishing weight is attached to a fishing line with attachment means 6. The fishing line runs from the lure to the reel on the boat, with the weight positioned proximate to the lure as desired. When fishing from a stationary position, the weight is dropped into the water and sinks to the desired depth quickly. When trolling, the fishing weight features reduced drag and water resistance, allowing it to maintain depth with less fishing line than conventional weights.

As well, the stability fins 3, may be deflected to the left or right or in an upwards or downwards direction to preferentially direct the weight and attached lure to one side or the other of the boat or to a higher or lower depth when trolling.

A further feature of the fishing weight is an automatic “hook setting” action when the fish strikes the lure. When fish strikes, the fishing weight will rotate (pitch or yaw) about the centre of gravity of the fishing weight to give added impetus to setting the hook. In effect there is an automatic hook setting action.

Because the fishing weight appears as “bait fish” when towed and attracts predator fish, the weight itself may be adapted with hook means in the event a fish strikes the fishing weight.

Referring to FIG. 2, the important ratio is the diameter d of body 1 when compared to the length X of the torpedo body. A preferred ratio

$$\frac{x}{d}$$

is 18.86 with an acceptable ratio range of between 10-21.

As well, fishing depths and rearward spacing of the multiple fishing lines can be managed by using different weights. Fishing weights of differing sizes and weights according to the invention may be used to achieve different depths from multiple attachments to the same line or single attachments to multiple lines.

It has been found that a fishing weight having a weight of 10 oz. reaches a fishing depth of 40 feet in (4) four seconds (sink rate of 10 ft/sec) which favourably compares with the down rigger.

An example of a suitable fishing weight is as follows. The fishing weight is made of suitable metal, such as stainless steel, which gives the fishing weight the required stiffness.

$$X = 9.42857 inches$$

$$D = 0.5 inches$$

$$Ratio = \frac{x}{d} = 18.85714$$

$$Weight \text{:} 10.79 oz .$$

By way of exception, if lead is used as the weight material, the preferred dimensions must be changed as follows to compensate for the softness of the material. The reduced ratio of 12/1 is not as efficient as the preferred ratio of 18.86 but acceptable nonetheless from a performance point of view.
X=7.125 inches
d=0.59375 inches
Ratio: 12/1
Weight: 10.06 oz.

Further advantages which are inherent to the formulation are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the following claims.

What is claimed:

1. A fishing weight comprising:
a. a torpedo shaped body of constant circular cross-section;
b. having a rounded nose;
c. stability fins at the rear integral with the body; and
d. means to attach fishing line to the body substantially above the center of gravity of the weight.

2. The weight claimed in claim 1 wherein the ratio of the length of the body to the cross-section is preferably between 10 and 21 to 1.

3. The weight claimed in claim 2 wherein the rear of said body is a cone structure curving downwardly and rearwardly at a preferred angle of between five and seven degrees from the longitudinal axis of the body.

4. The weight claimed in claim 3 wherein at least two stability fins are located opposite one another.

5. The weight claimed in claim 4 wherein the stability fins are deformable.

6. The weight claimed in claim 5 where the attachment means is integral to the body.

7. The weight claimed in claim 6 wherein the body material is stainless steel.

8. The weight claimed in claim 6 wherein the body material is lead.

9. The weight claimed in claim 8 wherein the body includes a stiffening member.

10. The weight claimed in claim 7 or 9 wherein the body is coated with a hydrophobic coating.
